(19) United States
(12) Patent Application Publication
(10) Pub. No.: US 2025/0196606 A1
(43) Pub. Date: Jun. 19, 2025

(54) THREE SPEED ELECTRIC VEHICLE TRANSMISSION

(71) Applicant: Dana Belgium N.V., Brugge (BE)

(72) Inventors: Pauwel COENEN, Aalter (BE); Filip D. SCHACHT, Meulebeke (BE); Kurt CATTOOR, Koolkerke (BE)

(21) Appl. No.: 18/957,136

(22) Filed: Nov. 22, 2024

Related U.S. Application Data
(60) Provisional application No. 63/609,497, filed on Dec. 13, 2023.

(51) Int. Cl. B60K 1/02; F16H 3/091

(52) U.S. Cl. CPC B60K 1/02; F16H 3/091; F16H 2200/0021

(57) ABSTRACT

Systems and method are herein provided for a three-speed electric transmission system. In one example, a transmission system includes a first electric motor coupled to an input speed reduction gear train, wherein the input speed reduction gear train rotationally couples to an input shaft; a second electric motor coupled to the input speed reduction gear train; a first clutch positioned on a first clutch shaft; a second clutch positioned on a second clutch shaft; a third clutch positioned on the first clutch shaft; an idler shaft; and an output shaft rotationally coupled to the idler shaft, wherein the output shaft is in one of a first position and a second position.

### CROSS REFERENCE TO RELATED APPLICATIONS

The present application claims priority to U.S. Provisional Application No. 63/609,497 entitled THREE SPEED ELECTRIC VEHICLE TRANSMISSION filed Dec. 13, 2023. The entire content of the above application is hereby incorporated by reference for all purposes.

### TECHNICAL FIELD

Embodiments of the subject matter disclosed herein relate to electric vehicles, and more specifically to electric vehicle transmission systems.

### BACKGROUND AND SUMMARY

Electric vehicles make use of electric drive units to generate motive power and provide an attractive alternative in terms of hydrocarbon emissions in relation to vehicles that solely rely on internal combustion engines for propulsion. Electric drive units often comprise transmission that include a plurality of clutches, gears, and shafts to transfer mechanical power from one or more motors to downstream components. Further, dual-motor systems have been utilized in some electric drive units to increase the drive units' power output and control adaptability. Increasing efficiency and optimizing functionality of a transmission design enhance performance of vehicles, especially electric and hybrid vehicles, which employ the transmission. Thus, a transmission with greater versatility may achieve higher efficiency and greater functional applicability in a broader range of vehicle types.

Some examples of such electric drive units of electric vehicles include a dual-motor drive unit where the motors are arranged on the same side of the transmission as well as multiple gears or clutches positioned on an output shaft. Further, some transmission systems of electric drive units include countershaft layouts as opposed planetary systems. However, high input speeds from the motors may result in degradation to internal components such as clutches and gears. Further, different applications may have different packaging demands. For example, loader-type vehicles may demand transmissions with a long drop from a main section of the transmission to the output because the transmission is assembled within the loader vertically higher with respect to the axles than other types of vehicles. Other types of vehicles, such as on-highway vehicles, may demand a short drop from the main section the transmission to the output. Because of this, certain transmission system layouts may not be applicable to multiple vehicle applications.

The inventors herein have recognized several drawbacks to such electric drive units. For example, including multiple gears or clutches on the output shaft increases the width of the transmission which may pose barriers to integration in certain vehicle platforms. Further, certain drop configurations may be incompatible in certain vehicles that demand shorter or longer drops due to packaging demands of surrounding vehicle systems, such as the long drop demanded by loaders. Further, due to the layout of clutches and associated gear reductions on downstream shafts included in previous electric drive units, the unit's width may not meet packaging demands of some vehicles. Additionally, high input speeds from electric motors may result in degradation to transmission components.

The inventors herein have recognized the aforementioned issues and developed a transmission system in an electric drive unit that at least partially addresses these issues. The electric drive unit, in one example, includes two electric motors and a transmission. The transmission may be a three speed electric transmission that comprises a plurality of clutches, a plurality of gears, and a plurality of shafts. In one embodiment, the transmission system comprises a first clutch, a second clutch, and a third clutch each positioned on a different shaft.

The transmission system allows for flexibility in an output shaft location. The output shaft may be arranged in a short drop configuration where an axis of an input shaft and an axis of the output shaft are close to aligning or long drop configuration where the axis of the input shaft and the axis of the output shaft are distanced further apart. The flexibility allows for a choice between the two configurations depending on the application, whereby the transmission system may be configured with a long drop configuration for applications that demand distance between input and output, such as loaders, or with a short drop configuration for applications that demand less distance between input and output. In this way, a single transmission design may be used for several vehicle types, rather than several transmissions with each being more specific to a certain vehicle type. Hence, a single more versatile transmission may reduce cost and complexity of manufacturing compared to producing multiple more limited transmission designs.

Further, the transmission system herein described is designed with flexibility of torque to speed ratio may be able to adapt to a broader range of driving conditions, including both on- and off-road driving. For driving conditions which require high torque, relatively high input speed is generally required. However, a transmission design which reduces input speed requirements and therefore speeds of internal components within a gearbox may minimize stress on components of the gearbox, thereby preventing failure of the components and prolonging a lifetime of the transmission. Speed reduction may also reduce drag losses on wet clutches, therefore efficiency may be increased with such a transmission.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of an exemplary vehicle.

FIG. 2 shows a schematic of a three-speed transmission system with an output in first position.

FIG. 3 shows a schematic of the three-speed transmission system with the output in a second position.

FIG. 4A shows a power path in the three-speed transmission system of FIG. 2 in a first operating gear ratio.

FIG. 4B shows a power path in the three-speed transmission system of FIG. 2 in a second operating gear ratio.

FIG. 4C shows a power path in the three-speed transmission system of FIG. 2 in a third operating gear ratio.

FIG. 5 shows a flowchart illustrating a method of operation of the three-speed transmission system.

FIG. 6 shows a table of exemplary operational gear and clutch engagements of the three-speed transmission system.

### DETAILED DESCRIPTION

The following description relates to systems and methods for a three-speed countershaft transmission for an electric vehicle comprising two electric motors. The transmission system includes a plurality of clutches, shafts, and gears. In particular, the transmission system includes an input shaft, a first clutch shaft on which first and third clutches are positioned, a second clutch shaft on which a second clutch is positioned, an idler shaft, and an output shaft. In a first configuration, the output shaft is in a short drop position. In a second configuration, the output shaft is in a long drop position. The transmission system, in either configuration, therefore provides for three speeds from three gear ratios and is configurable into either of the output shaft positions based on vehicle platform demands.

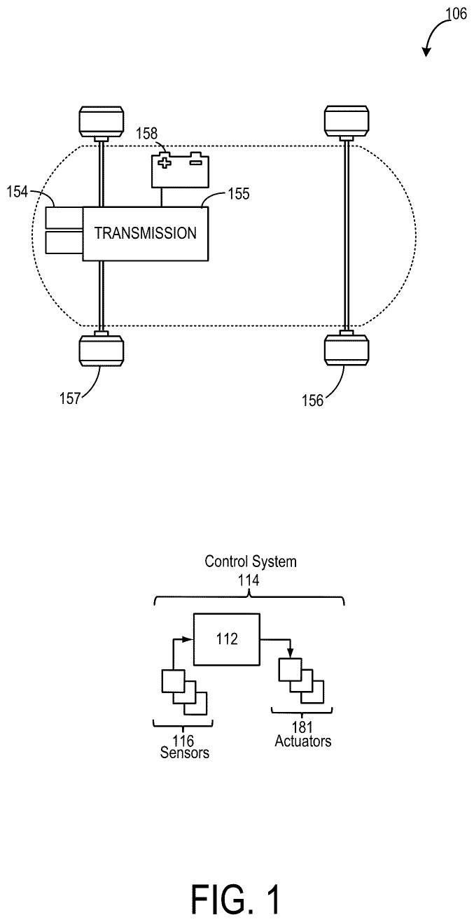

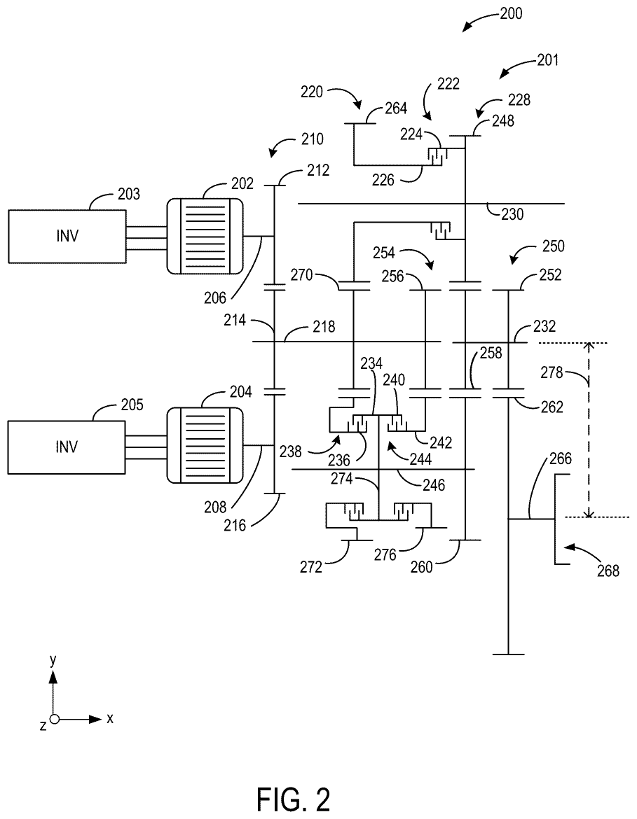

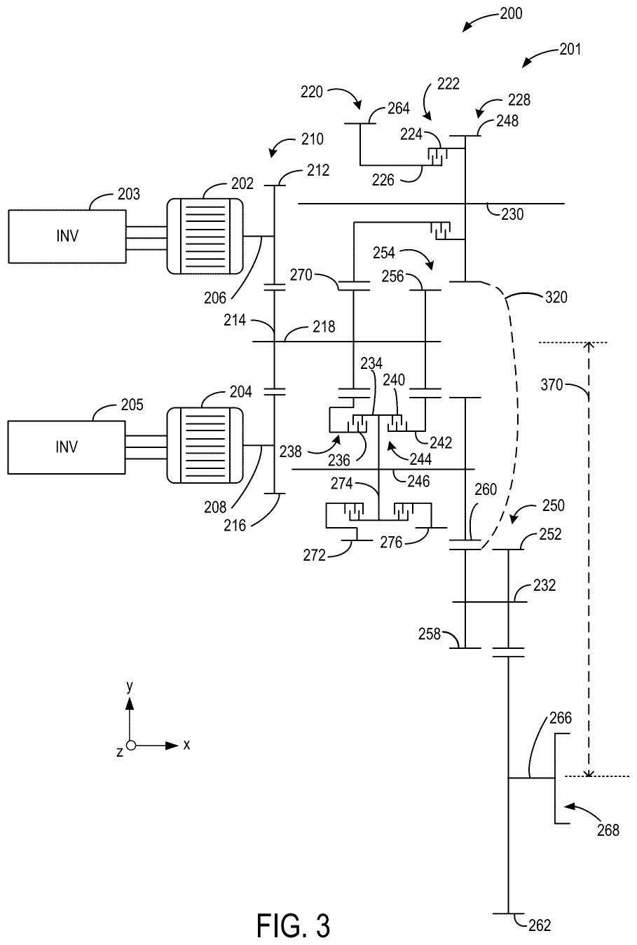

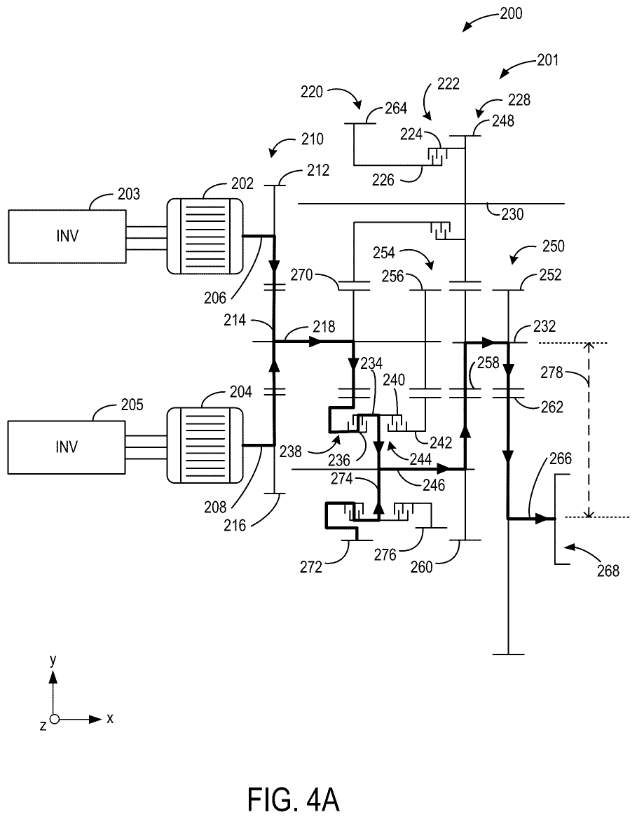

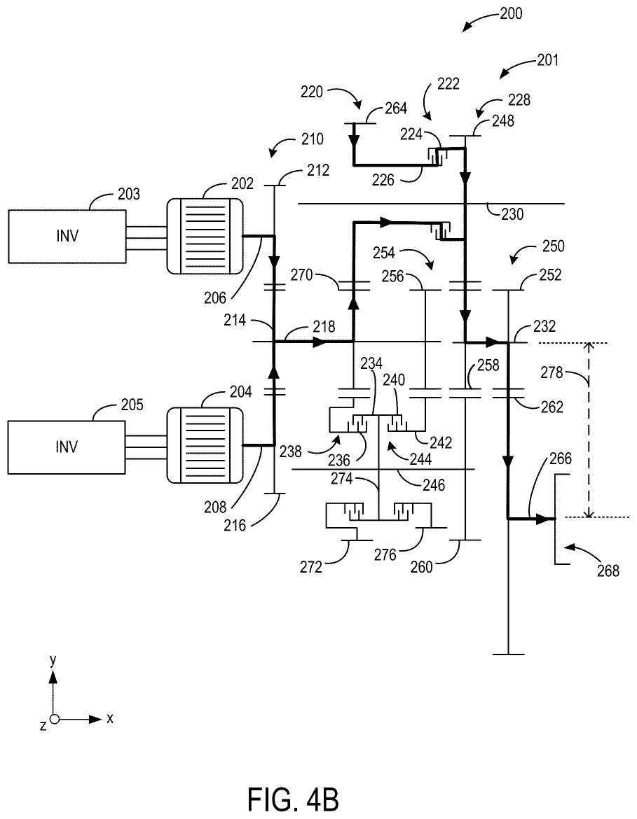

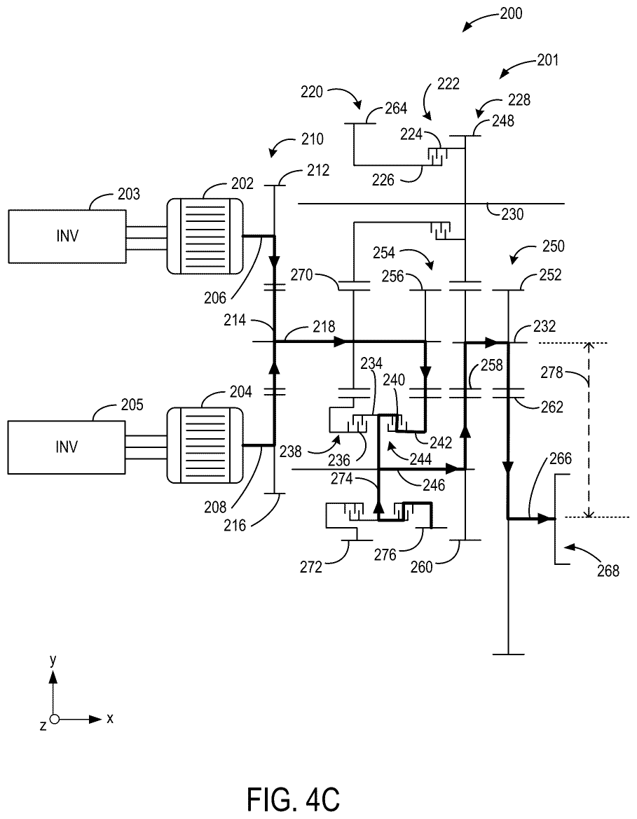

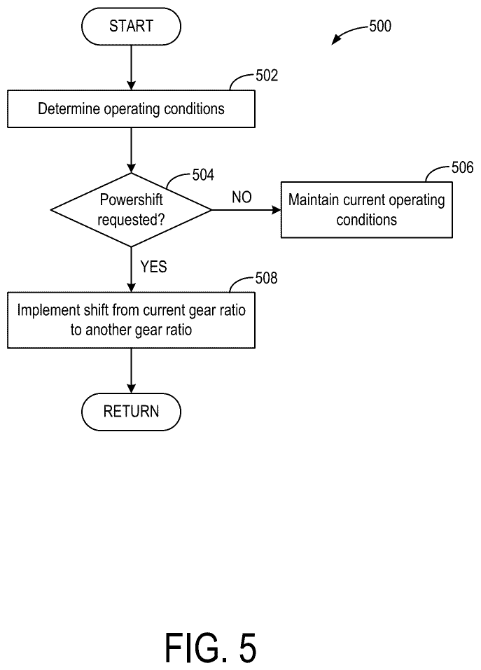

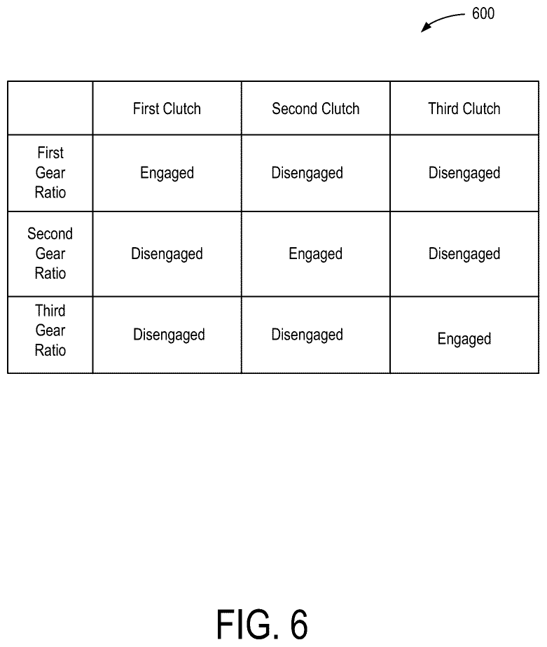

An exemplary electric vehicle is shown in FIG. 1. The layout of the transmission system is depicted schematically in diagrams in FIGS. 2-3, an output shaft in a first position in FIG. 2 and in a second position in FIG. 3. Power paths through the transmission system for first, second, and third gear ratios are shown in FIGS. 4A, 4B, and 4C, respectively. A method of operation of the transmission system is shown in a flowchart in FIG. 5. Clutch engagements for first, second, and third gear ratios are shown in a table in FIG. 6.

FIGS. 1-4C show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Turning now to the figures, FIG. 1 shows a schematic depiction of a vehicle system 106 that can derive propulsion power from one or more electric motors 154 (e.g., a drive motor). In some examples, the vehicle system 106 may be a front loader or compact wheel loader vehicle system. In one embodiment, electric motors 154 may be traction motors. Electric motors 154 receives electrical power from a traction battery 158 to provide torque to rear vehicle wheels 157 via transmission system 155. Electric motors 154 may also be operated as a generator to provide electrical power to charge traction battery 158, for example, during a braking operation. It should be appreciated that while FIG. 1 depicts electric motors 154 and transmission system 155 mounted in a rear wheel drive configuration, other configurations are possible, such as employing the electric motor 154 in a front wheel configuration, or in a configuration in which a first output yoke or other interface drives the rear vehicle wheels 157 and a second output yoke or other interface drives front vehicle wheels 156.

Electric motors 154 and transmission system 155 may be included as part of an electric drive unit. In some examples, the electric motors 154 may be integrated with a gearbox of the transmission system 155. Additionally or alternatively, the electric motor 154 may be coupled to an outside of a transmission/gearbox housing. The transmission/gearbox may include at least one clutch and one or more shafts, as will be described below. Controller 112 may send a signal to an actuator of the clutch(es) to engage or disengage the clutch(es), so as to couple or decouple power transmission from the electric motor 154 to various shafts and gears therein.

Controller 112 may form a portion of a control system 114. Control system 114 is shown receiving information from a plurality of sensors 116 and sending control signals to a plurality of actuators 181. As one example, sensors 116 may include sensors such as a battery state of charge sensor, clutch pressure sensor, speed sensors etc. As another example, the actuators may include the clutch(es), etc. The controller 112 may receive input data from the various sensors, process the input data, and trigger the actuators in response to the processed input data based on instruction or code programmed therein corresponding to one or more routines.

Turning now to FIG. 2, a schematic layout of an exemplary electric transmission system 200 according to the present disclosure is shown. For reference, an axis system is provided in FIG. 2, as well as in FIGS. 3-4C. The y-axis may be a vertical axis (e.g., parallel to a gravitational axis), the x-axis may be a lateral axis (e.g., a horizontal axis), and/or the z-axis may be a longitudinal axis. However, the axes may have other orientations in other examples, for example the y-axis may be a lateral axis and the x-axis may be a vertical axis in another example. The transmission system 200 is shown in FIG. 2 with an output shaft 266 in a first position. The transmission system 200 is shown in FIG. 3 with the output shaft 266 in a second position. Thus, the transmission system 200 may be configured in either position, where the first position may include the output shaft 266 in a long drop configuration and the second position may include the output shaft 266 in a short drop configuration. Additionally, the transmission system 200 may be a single drum design, in some examples.

The transmission system 200 may comprise a first electric motor 202, a second electric motor 204, and a multi-speed transmission 201 (e.g., a three-speed transmission). The transmission system 200 may therefore be a multi-speed (e.g., three-speed) transmission system. The transmission system 200 may comprise a plurality of clutches, including a first clutch 238, a second clutch 222, and a third clutch 244. The transmission system 200 may further comprise a plurality of shafts, including an input shaft 218, a first clutch shaft 246, a second clutch shaft 230, an idler shaft 232, and an output shaft 266. The plurality of shafts is rotationally coupled via a plurality of gears, as described further below. The gears of the transmission system 200 may be conceptually partitioned into a plurality of gear trains, including a first gear train 210, a second gear train 220, a third gear train 254, a fourth gear train 228, and a fifth gear train 250.

The first and second electric motors 202, 204 may include conventional components such as rotors and stators that electromagnetically interact during operation to generate motive power. Further, in one example, the electric motors may be motor-generators which are designed to generate electrical energy during regenerative operation. Still further, the electric motors may have similar designs and sizes, in some instances. In this way, manufacturing efficiency may be increased. However, the electric motors may have differing sizes and/or designs in alternate examples.

Each of the first and second electric motors 202, 204 may be configured to provide a desired amount of tractive power for operation of the vehicle, such as vehicle system 106, as well as a target top speed and speed on ramp. The use of multiple motors in the system therefore enables the system to attain end-use performance goals. Each of the first and second electric motors 202, 204 may be electrically coupled to one or more energy storage devices (e.g., one or more traction batteries, capacitor(s), fuel cells, combinations thereof, and the like) by way of first inverter 203 and second inverter 205, respectively. In one use-case example, the first and second electric motors 202, 204 and the respective first and second inverters 203, 205 may be three-phase devices. However, motors and inverters designed to operate using more than three phases have been envisioned.

The first electric motor 202 may comprise a first rotor shaft 206 that rotationally couples to the multi-speed transmission 201 for transfer of mechanical/rotational power from the first electric motor 202 into the multi-speed transmission 201. Similarly, the second electric motor 204 may comprise a second rotor shaft 208 that rotationally couples to the multi-speed transmission 201. Each of the first and second rotor shafts 206 and 208 may be rotationally coupled to the first gear train 210. For example, the first rotor shaft 206 may rotationally couple to gear 212, which meshes with gear 214 and the second rotor shaft 208 may rotationally couple to gear 216, which meshes with gear 214. The first gear train 210 therefore comprises gears 212, 214, and 216. In the depicted example layout shown in the second embodiment, the first electric motor 202 is arranged vertically above the second electric motor 204. However, it should be appreciated that alternative arrangements are possible without departing from the scope of this disclosure. For example, the first and second motors 202, 204 may be arranged along a shared horizontal axis and may be arranged vertically above the transmission 201.

The first and second electric motors 202, 204 may output a relatively low torque due to high input speeds. The first gear train 210 may be configured as an input speed reduction gear train. One embodiment of a method for an input reduction gear train is described. One or more drive input shafts (e.g., one or both of the first and second rotor shafts 206, 208) rotate at an input speed. When two shift elements of the input speed reduction gear train are engaged (for example, meshed), the output shaft of the reduction gear train (e.g., input shaft 218) rotates at an output speed. The output speed may be lower than the input speed, thus allowing for the input speed to be high without resulting in high output speeds. Reducing high input speeds through the transmission may mitigate degradation to components of the transmission system, such as clutches, gears, bearings, and the like. Reducing high input speeds may also reduce size of the gears of the system, thereby reducing an overall package size.

The gear 214 of the first gear train 210 may rotationally couple to input shaft 218. The input shaft 218 may further rotationally couple to second gear train 220 via gear 270. The second gear train 220 may comprise the gear 270, first clutch gear 272, and second clutch gear 264, wherein the second clutch gear 264 meshes with the gear 270 and the first clutch gear 272 meshes with the gear 270 opposite the second clutch gear 264. In the illustrated example, the second clutch gear 264 is positioned vertically above the gear 270 which is positioned vertically above the first clutch gear 272. However, in other examples, the second gear train 220 may be arranged horizontally such that the first clutch gear 272, gear 270, and second clutch gear 264 are coaxial along a shared horizontal axis.

The first clutch 238 may comprise a first clutch hub 236 and a first clutch drum 234 that selectively engage when the first clutch 238 is engaged. The first clutch hub 236 may fixedly couple to or otherwise be formed as part of the first clutch gear 272. The first clutch drum 234 may fixedly couple to or otherwise be formed as part of gear 274. The first clutch hub 236 and the first clutch drum 234 may selectively engage when the first clutch 238 is engaged. The gear 274 may also be fixedly coupled to or otherwise formed with third clutch drum 240 of the third clutch 244 on an opposing side from the first clutch drum 234. For example, the third clutch drum 240 and the first clutch drum 234 may be welded to the gear 274 on opposite sides. In such examples, the first and third clutches 238, 244 may be formed together as a multi-range clutch that has the first clutch engaged, the third clutch engaged, or in a middle, idle position where neither the first or third clutches are engaged. The third clutch 244 may further comprise a third clutch hub 242 that selectively engages with the third clutch drum 240 when the third clutch 244 is engaged. The third clutch hub 242 may be fixedly coupled to or otherwise be formed as part of third clutch gear 276.

The third clutch gear 276 may mesh with gear 256. Third clutch gear 276 and gear 256 may form the third gear train 254. The gear 256 may rotationally couple to the input shaft 218 such that the input shaft rotationally couples to both the second gear train 220 and the third gear train 254. As such, rotation of the input shaft 218 may transfer power through the first clutch 238, when engaged, via the second gear train 220 and through the third clutch 244, when engaged, via the third gear train 254.

The gear 274 may rotationally couple to first clutch shaft 246. The first clutch shaft 246 may further rotationally couple to the fourth gear train 228 via gear 260. The fourth gear train 228 may comprise the gear 260, gear 258, and gear 248. In the short drop configuration of the transmission system 200 as depicted in FIG. 2, the gear 248 may mesh with the gear 258, which may also mesh with the gear 260. In the depicted example of the first configuration, the gear 248 is positioned vertically above the gear 258 which is positioned vertically above the gear 260, however alternative arrangements are possible depending upon axes orientations as previously discussed.

The gear 248 of the fourth gear train 228 may rotationally couple to second clutch shaft 230. Further, the gear 248 may fixedly couple to or otherwise be formed as part of second clutch hub 224. For example, the second clutch hub 224 may be welded to the gear 248. The second clutch hub 224 may selectively engage with second clutch drum 226 when the second clutch 222 is engaged. The second clutch drum 226 may fixedly couple to or otherwise be formed as part of the second clutch gear 264 of the second gear train 220. As such, rotation of the input shaft 218 may be transferred through the second clutch 222, when engaged, via the second gear train 220.

Turning briefly to FIG. 6, a table 600 is shown of clutch engagements for gear ratios of the transmission system herein described. In the first gear ratio, a first clutch (e.g., first clutch 238) is engaged while a second clutch (e.g., second clutch 222) and a third clutch (e.g., third clutch 244) are disengaged. In the second gear ratio, the first clutch is disengaged, the second clutch is engaged, and the third clutch is disengaged. In the third gear ratio, the first and second clutches are disengaged and the third clutch is engaged.

Returning to FIG. 2, gear 258 may be rotationally coupled to idler shaft 232, which may further rotationally couple to the fifth gear train 250 via gear 252. The fifth gear train 250 may comprise the gear 252 as well as output gear 262. The gear 252 may mesh with the output gear 262, which may rotationally couple to output shaft 266. The output shaft 266 may couple to one or more output interfaces 268. The one or more output interfaces may be designed to attach to axles (not shown) via shafts, couplings, changes, combinations thereof, and/or the like. Such axles may include components such as differentials, axle shafts, and drive wheels (e.g., front vehicle wheels 156 and rear vehicle wheels 157 of FIG. 1). The output shaft 266 may thus be configured to transfer rotational torque to the axles. The output interfaces 268 may be flanges, yokes, splines, joints, combinations thereof, or the like.

As noted, gear 258 meshes with gear 260 in one of two positions. In FIG. 2, gear 258 meshes with the gear 260 in the first position, as previously noted. The first position may be with idler shaft 232 coaxial with or close to coaxial with an axis of the input shaft 218 As such, the output shaft 266 may be arranged a first distance 278 from the axis of the input shaft 218. The first position may thus define the short drop configuration for the output shaft 266. The short drop configuration may be utilized in applications that demand a short drop between the transmission and the axles, for example in applications in which the transmission is positioned in a vertical position close to an axis of the axles.

The first, second, and third clutches as herein described may be wet friction clutches, in some examples. In other examples, the clutches may be dog clutches, dry friction clutches, or other type of clutch. Wet friction clutches may allow for a smoother transition between engagement and disengagement, as compared to dog clutches. Further, lubrication of wet friction clutches may decrease degradation to the clutches over time, thereby increasing the longevity of the transmission system.

Turning now to FIG. 3, the transmission system 200 is again shown. Components of the transmission system 200 are unchanged compared to FIG. 2 and are thus given similar component numbering. The transmission system 200 as depicted in FIG. 3 includes the output shaft 266 in the second position, as previously noted.

In the second position of the idler shaft presented in FIG. 3, the gear 248 may still mesh with the gear 258, as noted by dashed line 320. In the second position, gear 258 may mesh with the gear 260 such that it is vertically below the gear 260. As such, the output shaft 266 may be positioned further vertically below the axis of the input shaft 218 than when in the first position. For example, a second distance 370 between the axis of the input shaft 218 and the axis of the output shaft 266 when the gear 258 and the idler shaft 232 are in the second position may be longer than the first distance 278 between the axis of the input shaft 218 and the axis of the output shaft 266 when the gear 258 and idler shaft 232 are in the first position. In this way, the second position of the gear 258 and idler shaft 232 may be a long drop configuration of the transmission system 200. The long drop configuration may allow for the transmission system to be utilized for applications that demand a long drop between a main section of the transmission (e.g., the axis of the input shaft) and the output. For example, loaders may demand a long drop due to the transmission being assembled/positioned higher with respect to the axles.

In some examples, the transmission system 200 may be assembled in one of the first configuration (the short drop configuration) and the second configuration (the long drop configuration) to fit an intended vehicle platform. In this way, manufacture of the transmission system 200 may be streamlined and tailored to the intended vehicle platform, thereby mitigating need to manufacture separate transmission systems with different components for different applications.

Turning now to FIGS. 4A-4C, power paths through the transmission system 200 in the first, short drop configuration (e.g., with the output shaft in the first position) are shown. FIG. 4A specifically shows a power path through the transmission system 200 when in the first gear ratio, FIG. 4B specifically shows a power path through the transmission system 200 when in the second gear ratio, and FIG. 4C specifically shows a power path through the transmission system 200 when in the third gear ratio. It should be understood that the power paths as described may also apply to the transmission system 200 in the long drop configuration.

In the power path of the first gear ratio as depicted in FIG. 4A, power of the first and second electric motors 202, 204 is transferred into the input shaft 218 via the first and second rotor shafts 206, 208, respectively, the gear 212 and the gear 216, respectively, and the gear 214 (e.g., the first gear train 210). Power is then transferred from the input shaft 218 into the first clutch 238 via gear 270 and gear 272 with the first clutch 238 engaged. In this way, the input shaft 218 is selectively rotationally coupled to the first clutch shaft 246 via the first clutch gear 272 when the first clutch 238 is engaged (e.g., in the first gear ratio). From the first clutch 238, power is transferred into first clutch shaft 246, from first clutch shaft 246 into gear 260, and from gear 260 to gear 258. From the gear 258, power is transferred to idler shaft 232, from idler shaft 232 to gear 252, from gear 252 to output gear 262, and from output gear 262 to output shaft 266. Power is then transferred from the output shaft 266 to output interfaces 268 and to downstream components thereafter.

In the power path of the second gear ratio as depicted in FIG. 4B, power of the first and second electric motors 202, 204 is transferred into the input shaft 218 via the first gear train 210. From the input shaft 218, power is transferred into the second clutch 222 via the gear 264, when the second clutch 222 is engaged. In this way, the input shaft 218 is selectively rotationally coupled to the second clutch shaft 230 via the second clutch gear 264 when the second clutch 222 is engaged (e.g., in the second gear ratio). From the second clutch 222, power is transferred into gear 248. Power is then transferred from gear 248 into gear 258. From gear 258, power is transferred into idler shaft 232 and into gear 252, from gear 252 into output gear 262 and from output gear 262 into the output shaft 266. From the output shaft 266, power is transferred to output interfaces 268 and to downstream components thereafter.

In the power path of the third gear ratio as depicted in FIG. 4C, power of the first and second electric motors 202, 204 is transferred into the input shaft 218 via the first gear train 210. From the input shaft 218, power is transferred into the third gear train 254, specifically into gear 256. From the gear 256, power is transferred through third clutch gear 276. Power is then transferred through the third clutch 244 via the clutch gear 274, and into the first clutch shaft 246, when the third clutch 244 is engaged. In this way, the input shaft 218 is selectively rotationally coupled to the first clutch shaft 246 via the third clutch gear 274 when the third clutch 244 is engaged. From the first clutch shaft 246, power is transferred to gear 260, from gear 260 to gear 258, from gear 258 to idler shaft 232, from idler shaft 232 to gear 252, from gear 252 to output gear 262, and from output gear 262 to output shaft 266. Power is then transferred from the output shaft 266 to output interfaces 268 and to downstream components thereafter.

Referring now to FIG. 5, a method 500 for operation of a transmission system is shown. The method 500 may be carried out by the example of the transmission system herein described with respect to FIGS. 2-4C. However, the method 500 may be carried out via other suitable transmissions, in other examples. Furthermore, the method 500 may be implemented by a controller that includes a processor and memory, as previously described.

At 502, method 500 includes determining operating conditions. The operating conditions may include input device positions (e.g., gearshift lever position), clutch configuration(s), output speed, motor speeds, motor torques, total output torque, vehicle speed, vehicle load, ambient temperature, and the like. The operating conditions may be ascertained via sensor inputs, modeling, look-up tables, and other suitable techniques.

At 504, method 500 includes judging if a powershift in the transmission should be implemented for selective shifting of one or more clutches of respective motor-transmission subassemblies of the transmission system. Such a determination may be carried out responsive to vehicle speed surpassing a threshold value, actual output torque, and/or accelerator pedal position, in some examples. In other examples, operator interaction with a gear selector and/or clutch actuator may initiate powershift operation.

If it is determined that a powershift should not occur (NO at 504), the method proceeds to 506 where the method 500 includes maintaining the current transmission operating conditions of the transmission system. For instance, the transmission system may be maintained in the first gear ratio.

Conversely, if it is determined that a powershift should occur (YES at 504), the method moves to 508 where the method 500 includes shifting the gear ratio from a current gear ratio to another gear ratio. As noted, the transmission system may include three gear ratios, including a first gear ratio, a second gear ratio, and a third gear ratio. Determining the operating conditions at 502 may include determining current gear ratio as well as current clutch positions. As an example, a current gear ratio may be a first gear ratio and shifting may comprise powershift from the first gear ratio to a second gear ratio. Powershifting may comprise shifting from one gear to another with little to no power or torque interruption.

The technical effect of the systems and methods described herein is that the transmission system, in either described configuration, may have three available gear ratios for three available speeds. The available configurations, including a short drop configuration and a long drop configuration, may provide increased flexibility as the transmission system may be configured for the specific intended application based on a demanded distance between axis of the input shaft and axis of the output shaft. Further, inclusion of an input speed reduction gear set may mitigate degradation to components of the transmission system by decreasing output speeds through the transmission.

The disclosure also provides support for a transmission system, comprising: a first electric motor coupled to an input speed reduction gear train, wherein the input speed reduction gear train rotationally couples to an input shaft, a second electric motor coupled to the input speed reduction gear train, a first clutch positioned on a first clutch shaft, a second clutch positioned on a second clutch shaft, a third clutch positioned on the first clutch shaft, an idler shaft, and an output shaft rotationally coupled to the idler shaft, wherein the output shaft is in one of a first position and a second position. In a first example of the system, the first position is a short drop configuration wherein an axis of the output shaft is a first distance from an axis of the input shaft, and the second position is a long drop configuration wherein the axis of the output shaft is a second, further distance from the axis of the input shaft. In a second example of the system, optionally including the first example, the input speed reduction gear train comprises a first gear, a second gear, and a third gear coupled in series, wherein the first gear couples to the first electric motor, the second gear rotationally couples to the input shaft, and the third gear couples to the second electric motor. In a third example of the system, optionally including one or both of the first and second examples, the input shaft is selectively rotationally coupled to the first clutch shaft via a first clutch gear of the first clutch when the first clutch is engaged and via a third clutch gear of the third clutch when the third clutch is engaged. In a fourth example of the system, optionally including one or more or each of the first through third examples, the input shaft is selectively rotationally coupled to the second clutch shaft via a second clutch gear of the second clutch when the second clutch is engaged. In a fifth example of the system, optionally including one or more or each of the first through fourth examples, the first clutch and the third clutch are configured together as a multi-range clutch, wherein, in a first position of the multi-range clutch, the first clutch is engaged, and in a second position of the multi-range clutch, the third clutch is engaged. In a sixth example of the system, optionally including one or more or each of the first through fifth examples when the first clutch is engaged and the second and third clutches are disengaged, the transmission system is in a first gear ratio, when the second clutch is engaged and the first and third clutches are disengaged, the transmission system is in a second gear ratio, and when the third clutch is engaged and the first and second clutches are disengaged, the transmission system is in a third gear ratio.

The disclosure also provides support for a multi-speed transmission, comprising: an input shaft coupled to a first electric motor and a second electric motor via a first gear train, a first clutch shaft selectively coupled to the input shaft via one of a second gear train and a third gear train depending on a selected gear ratio, a second clutch shaft selectively coupled to the first clutch shaft via the second gear train, an idler shaft coupled to the first clutch shaft and the second clutch shaft via a fourth gear train, and an output shaft coupled to the idler shaft via a fifth gear train in one of a short drop configuration and a long drop configuration, wherein a multi-range clutch, including a first clutch and a third clutch, is positioned on the first clutch shaft and a second clutch is positioned on the second clutch shaft. In a first example of the system, the first gear train comprises a first gear meshed with a second gear, which also meshes with a third gear, wherein the first gear is rotationally coupled to a first rotor shaft of the first electric motor, the second gear is rotationally coupled to the input shaft, and the third gear rotationally couples to a second rotor shaft of the second electric motor. In a second example of the system, optionally including the first example, the second gear train comprises a first gear fixedly coupled to the input shaft, a first clutch gear of the first clutch, and a second clutch gear of the second clutch, wherein the first clutch gear meshes with the first gear and the first gear meshes with the second clutch gear. In a third example of the system, optionally including one or both of the first and second examples, the third gear train comprises a first gear fixedly coupled to the input shaft and a third clutch gear of the third clutch, wherein the first gear meshes with the third clutch gear. In a fourth example of the system, optionally including one or more or each of the first through third examples, the fourth gear train comprises a first gear fixedly coupled to the second clutch shaft, a second gear fixedly coupled to the idler shaft, and a third gear fixedly coupled to the first clutch shaft, wherein the first gear meshes with the second gear and the second gear meshes with the third gear. In a fifth example of the system, optionally including one or more or each of the first through fourth examples, the fifth gear train comprises a first gear fixedly coupled to the idler shaft and an output gear fixedly coupled to the output shaft, wherein the first gear meshes with the output gear. In a sixth example of the system, optionally including one or more or each of the first through fifth examples in the short drop configuration, an axis of the output shaft is a first distance from an axis of the input shaft and, in the long drop configuration, the axis of the output shaft is a second, further distance from the axis of the input shaft. In a seventh example of the system, optionally including one or more or each of the first through sixth examples in a first gear ratio, the first clutch is selectively engaged with the first clutch shaft, in a second gear ratio, the second clutch is selectively engaged with the second clutch shaft, and in a third gear ratio, the third clutch is selectively engaged with the first clutch shaft.

The disclosure also provides support for an electric drive unit, comprising: a transmission system comprising: an input shaft, a first clutch shaft, a second clutch shaft, an idler shaft, a first clutch configured to selectively engage the first clutch shaft, a second clutch configured to selectively engage the second clutch shaft, a third clutch configured to selectively engage the first clutch shaft, and an output shaft coupled to the idler shaft, wherein the output shaft is positioned in one of a first and second position relative to the input shaft, and one or more electric motors, wherein each of the one or more electric motors is coupled to the input shaft of the transmission system. In a first example of the system, the first and third clutches are configured as a multi-range clutch, wherein both the first and third clutches are rotationally coupled to the input shaft via the same gear. In a second example of the system, optionally including the first example, the first position is a short drop configuration wherein an axis of the output shaft is a first distance from an axis of the input shaft, and the second position is a long drop configuration wherein the axis of the output shaft is a second, further distance from the axis of the input shaft. In a third example of the system, optionally including one or both of the first and second examples, the input shaft is rotationally coupled to the first clutch shaft via the first clutch when the first clutch is engaged with the first clutch shaft and via the third clutch when the third clutch is engaged with the first clutch shaft. In a fourth example of the system, optionally including one or more or each of the first through third examples, the idler shaft is rotationally coupled to the first clutch shaft and the second clutch shaft.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A transmission system, comprising:
a first electric motor coupled to an input speed reduction gear train, wherein the input speed reduction gear train rotationally couples to an input shaft;
a second electric motor coupled to the input speed reduction gear train;
a first clutch positioned on a first clutch shaft;
a second clutch positioned on a second clutch shaft;
a third clutch positioned on the first clutch shaft;
an idler shaft; and
an output shaft rotationally coupled to the idler shaft, wherein the output shaft is in one of a first position and a second position.

2. The transmission system of claim 1, wherein the first position is a short drop configuration wherein an axis of the output shaft is a first distance from an axis of the input shaft, and the second position is a long drop configuration wherein the axis of the output shaft is a second, further distance from the axis of the input shaft.

3. The transmission system of claim 1, wherein the input speed reduction gear train comprises a first gear, a second gear, and a third gear coupled in series, wherein the first gear couples to the first electric motor, the second gear rotationally couples to the input shaft, and the third gear couples to the second electric motor.

4. The transmission system of claim 1, wherein the input shaft is selectively rotationally coupled to the first clutch shaft via a first clutch gear of the first clutch when the first clutch is engaged and via a third clutch gear of the third clutch when the third clutch is engaged.

5. The transmission system of claim 1, wherein the input shaft is selectively rotationally coupled to the second clutch shaft via a second clutch gear of the second clutch when the second clutch is engaged.

6. The transmission system of claim 1, wherein the first clutch and the third clutch are configured together as a multi-range clutch, wherein, in a first position of the multi-range clutch, the first clutch is engaged, and in a second position of the multi-range clutch, the third clutch is engaged.

7. The transmission system of claim 1, wherein, when the first clutch is engaged and the second and third clutches are disengaged, the transmission system is in a first gear ratio, when the second clutch is engaged and the first and third clutches are disengaged, the transmission system is in a second gear ratio, and when the third clutch is engaged and the first and second clutches are disengaged, the transmission system is in a third gear ratio.

8. A multi-speed transmission, comprising:
an input shaft coupled to a first electric motor and a second electric motor via a first gear train;
a first clutch shaft selectively coupled to the input shaft via one of a second gear train and a third gear train depending on a selected gear ratio;
a second clutch shaft selectively coupled to the first clutch shaft via the second gear train;
an idler shaft coupled to the first clutch shaft and the second clutch shaft via a fourth gear train; and
an output shaft coupled to the idler shaft via a fifth gear train in one of a short drop configuration and a long drop configuration, wherein a multi-range clutch, including a first clutch and a third clutch, is positioned on the first clutch shaft and a second clutch is positioned on the second clutch shaft.

9. The multi-speed transmission of claim 8, wherein the first gear train comprises a first gear meshed with a second gear, which also meshes with a third gear, wherein the first gear is rotationally coupled to a first rotor shaft of the first electric motor, the second gear is rotationally coupled to the input shaft, and the third gear rotationally couples to a second rotor shaft of the second electric motor.

10. The multi-speed transmission of claim 8, wherein the second gear train comprises a first gear fixedly coupled to the input shaft, a first clutch gear of the first clutch, and a second clutch gear of the second clutch, wherein the first clutch gear meshes with the first gear and the first gear meshes with the second clutch gear.

11. The multi-speed transmission of claim 8, wherein the third gear train comprises a first gear fixedly coupled to the input shaft and a third clutch gear of the third clutch, wherein the first gear meshes with the third clutch gear.

12. The multi-speed transmission of claim 8, wherein the fourth gear train comprises a first gear fixedly coupled to the second clutch shaft, a second gear fixedly coupled to the idler shaft, and a third gear fixedly coupled to the first clutch shaft, wherein the first gear meshes with the second gear and the second gear meshes with the third gear.

13. The multi-speed transmission of claim 8, wherein the fifth gear train comprises a first gear fixedly coupled to the idler shaft and an output gear fixedly coupled to the output shaft, wherein the first gear meshes with the output gear.

14. The multi-speed transmission of claim 8, wherein, in the short drop configuration, an axis of the output shaft is a first distance from an axis of the input shaft and, in the long drop configuration, the axis of the output shaft is a second, further distance from the axis of the input shaft.

15. The multi-speed transmission of claim 8, wherein, in a first gear ratio, the first clutch is selectively engaged with the first clutch shaft, in a second gear ratio, the second clutch is selectively engaged with the second clutch shaft, and in a third gear ratio, the third clutch is selectively engaged with the first clutch shaft.

16. An electric drive unit, comprising:
a transmission system comprising:
an input shaft;
a first clutch shaft;
a second clutch shaft;
an idler shaft;
a first clutch configured to selectively engage the first clutch shaft;
a second clutch configured to selectively engage the second clutch shaft;
a third clutch configured to selectively engage the first clutch shaft; and
an output shaft coupled to the idler shaft, wherein the output shaft is positioned in one of a first and second position relative to the input shaft; and
one or more electric motors, wherein each of the one or more electric motors is coupled to the input shaft of the transmission system.

17. The electric drive unit of claim 16, wherein the first and third clutches are configured as a multi-range clutch, wherein both the first and third clutches are rotationally coupled to the input shaft via the same gear.

18. The electric drive unit of claim 16, wherein the first position is a short drop configuration wherein an axis of the output shaft is a first distance from an axis of the input shaft, and the second position is a long drop configuration wherein the axis of the output shaft is a second, further distance from the axis of the input shaft.

19. The electric drive unit of claim 16, wherein the input shaft is rotationally coupled to the first clutch shaft via the first clutch when the first clutch is engaged with the first clutch shaft and via the third clutch when the third clutch is engaged with the first clutch shaft.

20. The electric drive unit of claim 16, wherein the idler shaft is rotationally coupled to the first clutch shaft and the second clutch shaft.
